(19) United States
(12) Patent Application Publication
(10) Pub. No.: US 2011/0241359 A1
(43) Pub. Date: Oct. 6, 2011

(54) ELECTROMECHANICAL BLOCKING DEVICE, PARTICULARLY FOR THE DOOR OF AN AIRPLANE

(75) Inventor: Lothar Trunk, Weibersbrunn (DE)

(73) Assignee: DIEHL AEROSPACE GMBH, Ueberlingen (DE)

(21) Appl. No.: 13/132,407

(22) PCT Filed: Nov. 25, 2009
(86) PCT No.: PCT/EP2009/008365

§ 371 Date: Jun. 2, 2011

(30) Foreign Application Priority Data
Dec. 10, 2008 (DE) 10 2008 061 457.2
Mar. 24, 2009 (DE) 10 2009 014 528.1

(51) Int. Cl. E05C 3/12; B64C 1/14; E05C 19/16

(52) U.S. Cl. 292/196

(57) ABSTRACT

A blocking device (11) for a door locking system, in particular on the cabin door (10) of a passenger airplane, has a locking disk (12) with a link (13) which is stepped in such a way that, depending on whether an electromagnet (19) is turned on or turned off, the sliding block (15) of a sensing lever (14) either strikes a link stop (20) or runs into a free-running area (17) of the link when the door (10) or the locking elements of said door is/are moved as a result of being coupled in terms of movement to the locking disk (12).

The invention relates to an electromechanical blocking device, in particular for preventing impermissible opening of a closed airplane door.

Civil air regulations require that the closed doors are electromechanically blocked during flight but can be opened manually in the event of a power outage.

To date, it has only been possible to achieve this by complex interaction of complicated actuator and lever structures. For this purpose, EP 1 529 144 B1 discloses electromotively holding a shaft in a blockade angular position against the restoring force of permanent magnets. In the event of a failure in the supply of power from the motor, the permanent magnets mounted firstly in the bearing housing and secondly on the shaft should turn the shaft back to a release angular position. However, this allows only small rotation angles, even when large-volume, that is to say heavy, permanent magnets are used because the magnets otherwise pivot too far out of their opposing position; especially since the restoring torque which can be exerted magnetically decreases exponentially over the distance between the interacting magnetic poles.

In light of such conditions, the present invention is based on the technical problem of specifying a small electromechanical blocking device which is suitable, in particular, for being fitted to doors of passenger airplanes, said electromechanical blocking device being able to function, in particular, without heavy motors and pairs of permanent magnets and even being able to provide greater levels of functional reliability.

According to the invention, this object is achieved by virtue of the features specified in the main claim. According to said claim, what is known as a locking disk here is provided for example in a cockpit or cabin door, the movement of said locking disk being functionally linked to operation of the door locking system or the door itself. The locking disk is equipped with a, for example rib-like or slot-like, long free-running link which has a lateral widened portion, which is designed in the form of a blocking stop, at its reversing end. When a door locking system is operated in order to be opened or as a result of the door itself being opened, the unblocked locking disk is displaced, by way of its long free-running area of the link, along the sliding block of a sensing lever which is connected in an articulated manner so as to be stationary. When, however, the locking disk is blocked, its stop, which is formed at the reversing end of the link, butts against the sliding block and thus blocks further movement of the locking disk, and the door cannot be unlocked or opened.

The sensing lever itself or a tension rod which is attached to said sensing lever is acted on by the field of an electromagnet, against the influence of a release spring, for the purpose of this blocking operation when or after the door is closed or locked. As a result, the sensing lever tends to shift laterally in the link. However, said sensing lever can do this only when its sliding block is directly at the blockade reversing end of the link, that is to say at the lateral widened portion of the link. This is always the case when the door is closed or locked. If the locking disk is now intended to be moved in order to open the door, its link stop strikes the sliding block, which is pivoted into the widened portion, and therefore it cannot be displaced back along the free-running area to its release position. As a result, the door locking system, which is mechanically coupled to the locking disk, and the door itself, in its position in which it is still closed, also remain blocked.

In the event of a power outage however, the magnetic attraction force on the sensing lever disappears, and it is pivoted back in a spring-loaded manner away from the blocking stop from the widened portion of the link into its previous position, in which it is ready to block, in front of the free-running area of the link. Therefore, the sliding block now no longer engages behind the blocking stop; it can re-enter its long free-running area of the link when the locking disk moves. As the bolts of the door locking system are moved back manually or directly during a door opening movement, the locking disk, which is now unblocked, can therefore again be displaced to a sufficient degree to allow the door to open. The sufficiently long length of the free-running area of the link promotes reliable release of the door which is to be opened itself or of the locking system of said door.

This blockade according to the invention can already be reliably realized with an actuator in the form of a small, lightweight electromagnet because the magnetic field required to overcome the restoring force of the release spring can be made available by means of a correspondingly powerful field current. If the electromagnet acts directly on the sensing lever, the arrangement of a soft-iron armature plate between the magnet and the sensing lever is expedient, so that the spring, for the purpose of pivoting the sensing lever back after the field current is discontinued, still does not have to overcome any remnent magnetic field. A solenoid or plunger coil system, in which a tension rod, which is connected in an articulated manner to the sensing lever, is retracted coaxially into the interior of a cylinder coil, through which current flows, against the restoring force of the release spring, has a degree of efficiency which is even better in this respect.

Additional alternatives to and developments of the solution according to the invention can be found in the further claims and, also in terms of their advantages, from the description below of preferred exemplary embodiments of the invention which are sketched in a manner abstracted to what is functionally essential and not entirely to scale, in which drawing, in each case in the position of the locking disk in which it is ready to block:

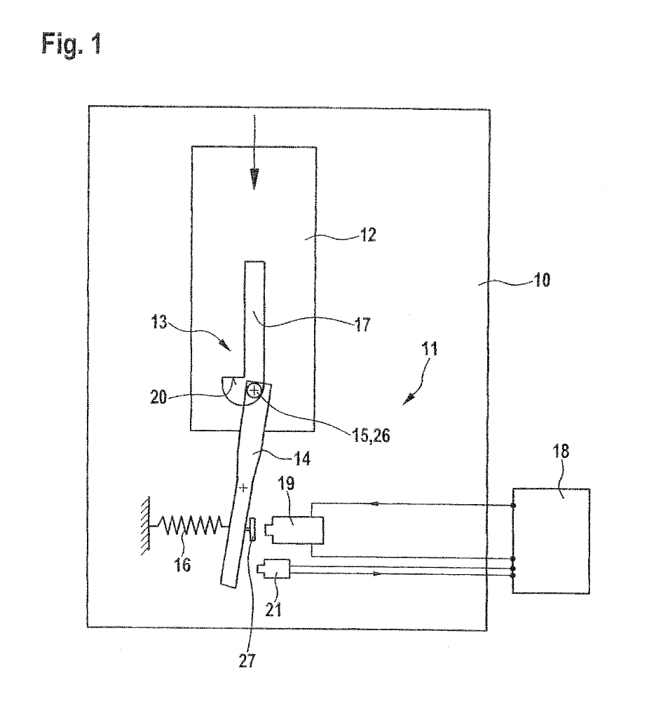

FIG. 1 shows the operating principle of the blocking device using the example of a locking disk which can be displaced in a linear manner,

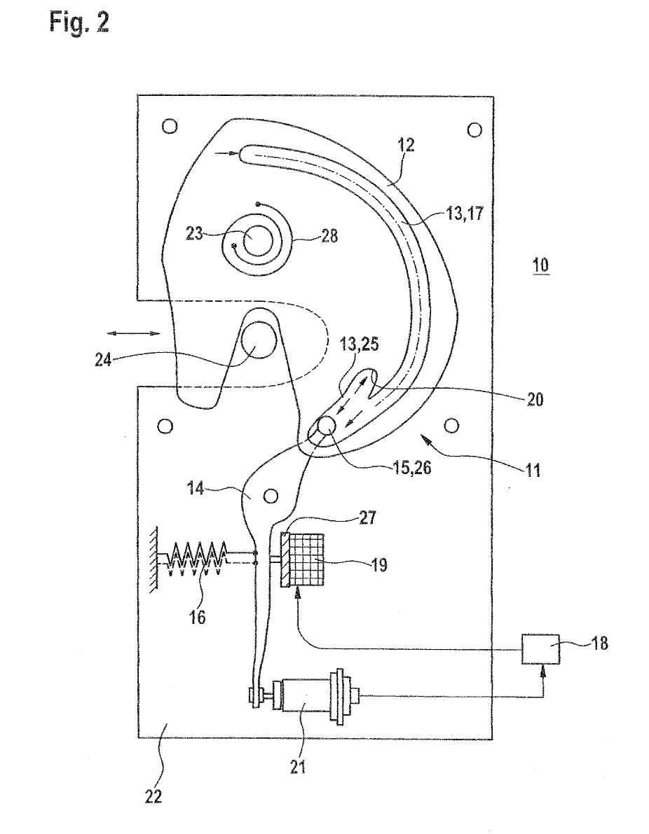

FIG. 2 shows, in a modification and development of the solution according to FIG. 1, a pivotable locking disk, and

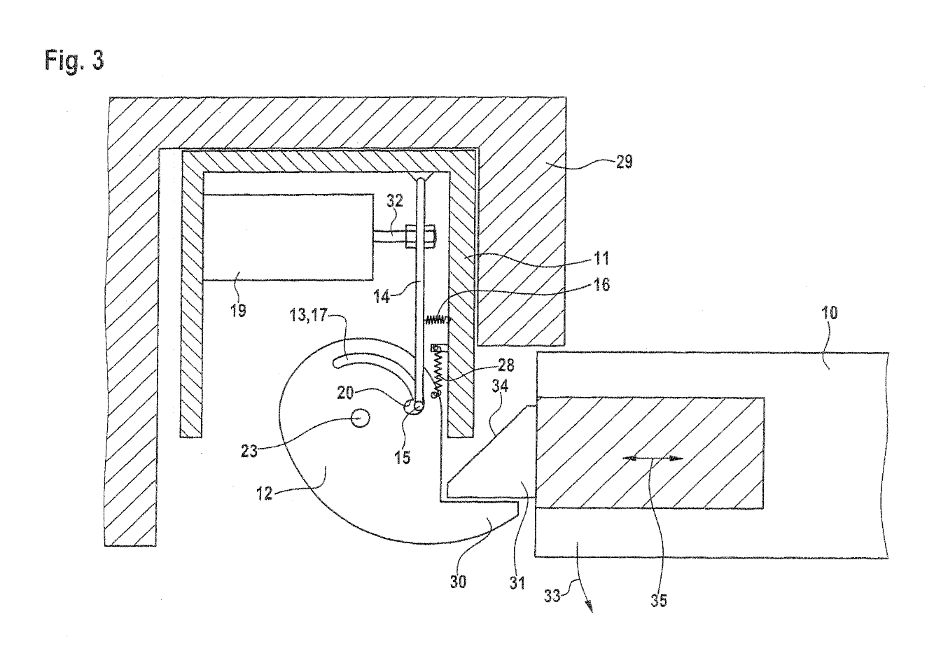

FIG. 3 shows a development of the solution according to FIG. 2 which is simplified in terms of equipment and improved in terms of operation.

The blocking device 11 according to the invention which is to be installed in the door 10 of an airplane cabin or a cockpit essentially has a mechanically displaceable solid locking disk 12 with a, in this case slot-like, link 13 formed on it. A sensing lever 14, which is sketched with one arm in this case and has a region which serves or is equipped as a sliding block 15, in this case in the end region of said sensing lever, engages in said link.

During the course of locking of the door 10, the locking disk 12 which is coupled to it by a gear mechanism moves over a longer path, counter to the indicated arrow direction, away from the sensing lever 14. Therefore, said sensing lever slides, by way of its sliding block 15, along a long free-running area 17 in the link 13 as far as the widened reversing end of said link. This is the situation sketched in each of the figures in the drawings.

The sensing lever 14, by way of its sliding block 15, is loaded by means of a release spring 16 in the direction away from the lateral widened portion of the link. Therefore, the sliding block 15 re-enters the free-running area 17 when the locking disk 12 is moved back in the arrow direction, for example on account of locking bolts (not shown) being retracted for the purpose of opening the door 10. The free-running area 17 then moves over the sliding block 15 without obstruction as far as a position of the locking disk 12 in which the door locking system is entirely released for opening purposes.

However, if such release of the door locking system is intended to be prevented, in order, for example, to reliably prevent a cabin or cockpit door from being opened while an airplane is in flight, an electromagnet 19, which has a pivoting effect on the sensing lever 14, is supplied with power from a superordinate control circuit 18. The field force of said electromagnet causes the sensing lever 14, by way of its sliding block 15, to be subjected to a pivoting load in the direction of the widened portion of the link at the reversing end of the link 13, and therefore finally to enter that widened portion where it engages behind a stop 20 which is formed in the manner of a shoulder there, when it leaves the free-running area 17 upon reaching the reversing end of the link 13.

An opening movement of the door locking system now causes the locking disk 12, after only minimal associated displacement, to strike the sliding block 15 by way of the stop 20 of the link 13 of said locking disk. This abutment therefore limits the movement options of the locking disk 12 to a small residual path which is reliably still not sufficient, for example, to release the door locking system by retracting its bolts.

The blocking device 11 is therefore in its blockade position by virtue of the magnetically pivoted sensing lever 14. This operating state can be detected by a proximity sensor 21 which is influenced by the position of the sensing lever 14 and which is, for example, simply an end switch, and can be reported to the control circuit 18 for further evaluation.

In the event of the power supply to the electromagnet 19 being interrupted—for example deliberately by means of the electromagnet 19 being turned off manually or in a sensor-controlled manner by means of the control circuit 18, but at least in the event of failure of the on-board electrical system—the blocking device 11 is released again because the restoring force of the spring 16, which restoring force permanently acts on the sensing lever 14, pivots the sensing lever 14, by way of its sliding block 15, back from the engagement region of the link stop 20 for the purpose of entry into the free-running area 17 of the link when the magnetic field disappears. As a result, after sufficiently long displacement of the locking disk 12, by way of its free-running area 17, along the sliding block 15, the locking of the door is lifted.

For a more compact structure, in spite of actuating paths which are as long as possible in the interests of reliability against disturbing influences and in particular for installation in the cabin or cockpit door 10 on board a passenger airplane, the blocking device 11, in contrast to the basic illustration of FIG. 1, is not equipped with a linearly displaceable locking disk 12 but with a locking disk 12 which can be rotated about a shaft stub 23, which is mounted on a base plate 22 for example, through a certain pivot angle. The link 13, which is again in the form of a slot in this exemplary embodiment too, in the locking disk 12 accordingly runs, by way of its long free-running area 17, in the manner of an arc around the shaft stub 23.

The rotary movement of the locking disk 12 by way of its link 13 takes place, for example, by means of a hand lever 24 which also serves to displace, for example, locking bolts for closing or opening the door 10. The hand lever 24 can act on the pivotable locking disk 12 in a concentric manner in relation to the shaft stub 23 and thus directly introduce a torque, or—for example as sketched in FIG. 2 for applying a torque by a linear movement—engage eccentrically with the locking disk 12.

At its laterally widened reversing end, the link 13 is now expediently branched asymmetrically in the shape of a V, with the stop 20 bearing on the blind end of the shorter limb 25 of the V. This ensures that the sliding block 15, in this case in the form of a guide or sensing roller 26 at an end region of a sensing lever 14 which is now mounted in a two-armed manner and runs in an angled manner, cannot be moved back from its blockade position against the stop 20 into the release position with entry into the free-running area 17, against the magnetic attraction force of the electromagnet 19 to which power is supplied in an unintentional manner, for example as a result of mechanical vibrations and under the influence of the restoring spring 16, as a result of which the door securing blockade would then be unintentionally lifted.

For the purpose of achieving a reliable retaining action of the electromagnet 19 for engaging behind the blockade stop 20 by way of the sliding block 15, that is to say when the sensing lever 14 is electromagnetically attracted, a soft-magnetic armature plate 27 is arranged between the electromagnet 19 and the region of the sensing lever 14 which is situated opposite it—also in order to virtually preclude an unintentionally lasting blockade as a result of permanent-magnet remanence phenomena when the magnet 19 is turned off again.

In order to lift the blockade in this way as a result of the electromagnet 19 being turned off, in the design of the link 13 according to FIG. 2, the locking disk 12, together with the door locking system, first has to be rotated further to some extent until the roller 26 emerges from the short limb 25 of the V at the reversing end of the link 13. This is because, here, in the vertical angle of the link between the two limbs, which are clearly of different lengths as sketched, of the link 13 which branches in the form of a V, the roller 26 is moved back to the entry region into the free-running area 17 under the influence of the release spring 16 when the electromagnet 19 is turned off. In the interests of release redundancy, this spring 16 is preferably implemented in duplicate, for example designed in the form of an integral double spring as sketched.

The abovementioned small manual displacement of the locking disk 12 in order to leave the short limb 25 of the V with its blocking stop 20 can be assisted, as taken into consideration in FIG. 2, by the torque of a torsion spring 28 which acts on the locking disk 12 around the shaft stub 23. However, this spring 28 is designed, in particular, to ensure that the locking disk 12 which is pivoted manually into the release position is not, where possible, unintentionally rotated back into the blockade angular position by means of abutment of the stop 20 against the sliding block 15 again as a result of vibration, but rather that the sliding block 15 can then reliably enter the free-running area 17.

In the embodiment variant according to FIG. 3, the blocking device 11 according to the invention is incorporated in the door opening, that is to say in the frame 29 of a cabin or cockpit door 10. The boundary of the locking disk 12, which can again be pivoted and dimensioned such that it can bear a corresponding load, runs in the manner of a worm to form a closing lug 30 for the catch 31 of the door 10 here. The prismatic armature 32 of a plunger coil electromagnet 19 is connected in an articulated manner to the sensing lever 14 which engages in the link 13 by way of its sliding block 15 and is again of one-armed design in this case.

When supplied with power in the sketched position of the locking disk 12, the armature 32 pulls the sliding block 15, again against the action of the release spring 16, behind the blockade stop 20 at the laterally widened reversing end of the free-running area 17. The door 10 is blocked from being opened by the lug 30 which thus cannot be pivoted.

The door 10 can first and only be opened, in the direction of the arcuate arrow 33, when the armature 32 is no longer activated, and therefore the sensing lever 14 is pivoted back to enter the free-running area 17 under the influence of the release spring 16.

Now—owing to the magnet 19 not being supplied with power and therefore the sliding block not engaging behind the stop 20—the locking disk 12, as a result of movement of the door 10 in the direction of the arcuate arrow 33, can be pivoted out of its position in which it is closed without being blocked, as sketched in FIG. 3, through up to approximately 90°, by means of the door catch 31 which engages behind the locking lug 30, as a result of which the sliding block 15 is displaced into the free-running area 17. The catch 31 is therefore no longer blocked by the lug 30 and the door 10 can open.

The torsion spring 28, which does not act on the locking disk 12 in the manner of a spiral around the shaft stub 23 of the locking disk 12 here, but rather in a linear and eccentric manner in relation to the shaft stub 23, is now designed to rotate the locking disk 12 back into the shown readiness position for an electromagnetic blockade after the door 10 is opened. The open door 10 can be closed again in this readiness position of the locking disk 12 by the ramp 34 of the catch 31 striking the locking lug 30 of the locking disk 12 and thus the catch 31 temporarily being pushed into the door 10, against the force of a restoring spring 35, until the catch 31, which is moved out again, engages behind the locking lug 30.

Therefore, the blocking device 11 according to the invention, which is designed in particular for the door 10 of a passenger airplane, has a locking disk 12 which can be displaced with the movement of the door 10 itself or the locking elements of said door and has a lateral blocking stop 20 at the reversing end of its link 13, with the sliding block 15 of a pivotable sensing lever 14 either engaging with a short stroke against a blocking stop 20 or else with a long stroke in a free-running area 17 which branches off at this point. The temporary reversal of the sensing lever 14 for the purpose of blocking a movement of the locking disk 12 is performed by supplying power to an electromagnet 19, the magnetic attraction force of said electromagnet overcoming the restoring force of a release spring 16 which always acts on the sensing lever 14 in the opposite direction.

### LIST OF REFERENCE SYMBOLS

10 Door
11 Blocking device (for 10 with 12)
12 Locking disk (of 11; with 13)
13 Link (for 15 in 12)
14 Sensing lever (with 15 in 13)
15 Sliding block (on 14 in 13)
16 Release spring (in the opposite direction to 19 and acting on 14)
17 Free-running area (of 13)
18 Control circuit (for 19)
19 Electromagnet (acting on 14 against 16)
20 Blocking stop (for 15 on 13)
21 Proximity sensor (for the position of 14)
22 Base plate (for mounting 11)
23 Shaft stub (on 22 for pivotably mounting 12)
24 Hand lever (for locking the door by pivoting 12 about 23)
25 Shorter limb of the V (with 20, next to 17)
26 Roller (on 14 in the form of 15, in 13 of 12)
27 Armature plate (on 14 for 19)
28 Torsion spring (on 12)
29 Frame (of 10)
30 Locking lug (on 12)
31 Catch (on 10, behind 30)
32 Plunger coil armature (in 19)
33 Arcuate arrow (opening movement of the door 10)
34 Ramp (of 31)
35 Restoring spring (in 10 for 31)

1. An electromechanical blocking device, for a door, in particular of a commercial airplane, having a locking disk and a sensing lever which engages with a link on the locking disk and engages behind a blocking stop under the influence of a magnet to which power is supplied, against the action of a release spring, in a laterally widened portion of the link.

2. The blocking device as claimed in claim 1, wherein a soft-magnetic armature plate is provided between the sensing lever and the magnet.

3. The blocking device as claimed in claim 2, wherein the armature of a plunger coil magnet is connected in an articulated manner to the sensing lever.

4. The blocking device as claimed in claim 1, wherein the sensing lever is under the influence of a double release spring in the release direction.

5. The blocking device as claimed in claim 1, wherein the sensing lever can be pivoted in the response region of a proximity sensor.

6. The blocking device as claimed in claim 5, wherein the proximity sensor is connected to a control circuit for supplying power to the electromagnet.

7. The blocking device as claimed in claim 1, wherein the stop is formed in a laterally offset manner at the reversing end of the free-running area.

8. The blocking device as claimed in claim 7, wherein the stop is positioned at the blind end of a limb of an asymmetrical V-shaped link, said limb being very short in relation to the free-running area.

9. The blocking device as claimed in claim 1, wherein the locking disk is mounted in a rotatable manner.

10. The blocking device as claimed in claim 9, wherein the locking disk is influenced by a torsion spring.

11. The blocking device as claimed in claim 1, wherein the locking disk has a lug for engaging behind a door catch.

12. The blocking device as claimed in claim 11, wherein the catch can be moved, against the force of a return spring, as a result of the ramp of said catch striking the lug.
